(19) United States
(12) Patent Application Publication
(10) Pub. No.: US 2025/0257238 A1
(43) Pub. Date: Aug. 14, 2025

(54) UV CURABLE COATING COMPOSITIONS CONTAINING ALIPHATIC URETHANE ACRYLATE RESINS

(71) Applicant: Eileen M. Weber, Evansville, IN (US)

(72) Inventor: Eileen M. Weber, Evansville, IN (US)

(21) Appl. No.: 19/193,363

(22) Filed: Apr. 29, 2025

Related U.S. Application Data
(63) Continuation-in-part of application No. 18/384,939, filed on Oct. 30, 2023, now Pat. No. 12,286,555.

(51) Int. Cl. C09D 175/16; C09D 7/40; C09D 7/61

(52) U.S. Cl. CPC C09D 175/16; C09D 7/61; C09D 7/67; C09D 7/68

(57) ABSTRACT

The invention provides UV curable coating compositions comprising a synergistic two-component system of aliphatic urethane acrylate resins. The first component is formed by reacting an aliphatic polyisocyanate containing iminooxadiazine dione, isocyanurate, uretdione, urethane, allophanate, biuret, or oxadiazine trione groups with a hydroxyl-functional acrylate. The second component is formed by reacting a multifunctional acrylate with an aliphatic urethane based on alkyl carbomoncycle diisocyanate. The components combine in specific ratios to create coatings with superior hardness, scratch resistance, chemical resistance, and weatherability for automotive applications. Quantifiable structure-property relationships define optimal formulations for specific applications including vehicle headlamp lenses and trim components. Also described are coated articles and methods for their production.

### CROSS-REFERENCE TO RELATED APPLICATIONS

This application is a continuation-in-part of U.S. patent application Ser. No. 18/384,939, filed Oct. 30, 2023 entitled “UV Curable Coating Compositions Containing Aliphatic Urethane Acrylate Resins,” now U.S. Pat. No. 12,286,555, which is a continuation of U.S. patent application Ser. No. 17/533,622, filed Nov. 23, 2021 entitled “UV Curable Coating Compositions Containing Aliphatic Urethane Acrylate Resins,” now U.S. Pat. No. 11,840,640, which is a continuation of U.S. patent application Ser. No. 16/431,336, filed Jun. 4, 2019 entitled “UV Curable Coating Compositions Containing Aliphatic Urethane Acrylate Resins,” now U.S. Pat. No. 11,180,675, which is a continuation of U.S. patent application Ser. No. 15/997,658, filed Jun. 4, 2018 entitled “UV Curable Coating Compositions Containing Aliphatic Urethane Acrylate Resins,” now U.S. Pat. No. 10,308,834, which is a continuation of U.S. patent application Ser. No. 14/828,814, filed Aug. 18, 2015 entitled “UV Curable Coating Compositions Containing Aliphatic Urethane Acrylate Resins,” now U.S. Pat. No. 9,988,556, which is a continuation of U.S. patent application Ser. No. 12/130,387, filed May 30, 2008 entitled “UV Curable Coating Compositions Containing Aliphatic Urethane Acrylate Resins,” now U.S. Pat. No. 9,109,139, which are hereby incorporated herein by reference in their entirety, including all references cited therein.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates generally to forming polymeric coatings on substrates, and in certain embodiments to coating compositions, coated articles, and methods for their production, that involve the use of a blend of selected types of resins. More particularly, the invention relates to UV curable coating compositions containing aliphatic urethane acrylate resins that provide superior scratch resistance, chemical resistance, and weatherability for plastic substrates used in automotive and other applications requiring high durability.

### 2. Background of the Invention

Plastic substrates such as but not limited to polycarbonate, acrylic and polyester often are used in a variety of applications as replacements for more traditional materials such as glass. Plastics can offer excellent properties such as impact resistance and optical clarity while providing weight reduction and abundant design flexibility. Despite the numerous benefits that plastic offers, they have a major drawback in that they often do not provide the desired degree of chemical, scratch, mar and abrasion resistance, UV resistance and/or exterior durability.

It is known that both conventional thermal cured and ultraviolet (UV) cured coatings for exterior applications exhibiting scratch and abrasion resistance have offered adequate protection and performance of these various plastic substrates when direct exposure angles or durations are limited. It is also known that UV cured coatings are often the preferred coating of choice because they offer distinct advantages such as improved cycles times and reduced work in process over conventionally cured alternatives.

Despite the many advantages of current exterior coatings—and more specifically of UV curable coatings—they still do not meet all the expectations and often lack desirable properties and combinations of properties that are very difficult to achieve with traditionally available technology. Traditional UV topcoats for scratch and abrasion resistant applications most often are comprised primarily of high functionality and highly reactive acrylates. Although these characteristics impart the desired hardness properties, they are prone to cured resin shrinkage and steric hindrance. The steric hindrance results in a higher than desired number of unreacted acrylate bonds in the cured polymer resin which make the cured coating more susceptible to premature UV and environmental degradation.

Additionally, known UV topcoats upon curing create a rigid, inflexible coating. Such inflexible coatings when subjected to conditions of expansion or contraction during processing or field use or when applied to materials containing high internal stress result in inadequate performance such as cracking, compromised exterior durability or other imperfections. Thus it can be difficult for a single coating composition to provide the desired level of a high surface hardness, scratch resistance, chemical resistance, UV resistance and exterior durability.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In certain aspects, the invention provides a coating composition that includes a unique blend of UV-curable resins. A first resin of the blend is an aliphatic urethane acrylate formed by the reaction of an aliphatic polyisocyanate component containing iminooxadiazine dione, isocyanurate, uretdione, urethane, allophanate, biuret or oxadiazine trione groups, with an alcohol component, for example with a molecular weight of about 100 to about 2000 g/Mol, and containing at least one monobasic, hydroxyl-functional linear or branched alkyl ester of meth(acrylic) acid. This coating composition also includes at least a second aliphatic urethane acrylate, which in certain embodiments (i) is formed by the reaction of a multifunctional acrylate with an aliphatic urethane based on a polymer of alkyl carbomoncycle diisocyanate; or (ii) is encompassed by Formula II as disclosed hereinbelow. In preferred aspects, the first aliphatic urethane acrylate has a molecular weight in the range of about 800 to about 2,500 g/Mol, and/or the first aliphatic urethane acrylate contains about 3 to about 5 polymerizable acrylate groups per molecule. In preferred aspects, the molecular weight of the second aliphatic urethane acrylate is in the range of about 500 to about 2,000 g/Mol. The coating compositions can also contain a solvent that assists in controlled application and processing of the material. The coating compositions can also contain at least two and more preferably three or more multifunctional acrylates each having molecular weights between 170 and 1,000 and a minimum of two polymerizable unsaturated groups per molecule. The coating compositions can also include stabilizers such as hindered amine light stabilizers and/or UV absorbers of the benzotriazole or benzotriazine families, or derivatives thereof. The coating compositions can also contain one or more organic-inorganic hybrid materials synthesized through a sol gel process.

In additional embodiments, the present invention provides coated articles and coating processes involving the use of the coating compositions described herein. In certain forms, an inventive coated article will have a base plastic material having a thickness of about 0.75 to 20 mm, and a cured top coating formed by reaction of a coating composition as described herein and having a thickness in the range of about 3 to about 35 microns. The cured top coating can provide a high degree of scratch, abrasion, mar and chemical resistance along with superior UV resistance, exterior durability and thermal stability. In certain forms, inventive processes will include the application of a coating composition as described herein by spray coat, flowcoat or curtain coat techniques.

### BRIEF DESCRIPTION OF THE DRAWINGS

Certain embodiments of the present invention are illustrated by the accompanying figures. It will be understood that certain figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a perspective partial cutaway of a vehicle having a coated forward lighting lens according to one aspect of the invention.

FIG. 2 of the drawings is a side partial cutaway of the vehicle of FIG. 1.

### DETAILED DESCRIPTION OF THE INVENTION

For the purposes of promoting an understanding of the principles of the invention, reference will now be made to certain embodiments and specific language will be used to describe the same. It will nevertheless be understood that no limitation of the scope of the invention is thereby intended, such alterations and further modifications in the illustrated device, and such further applications of the principles of the invention as described herein being contemplated as would normally occur to one skilled in the art to which the invention relates.

As disclosed above, in certain of its aspects, the present invention relates to unique coating compositions and to methods and coated articles that employ or include the coating compositions. In preferred forms, coating compositions include a novel blend of resins, the blend including first and second acrylated aliphatic urethane resins. Such coating compositions include at least a first urethane acrylate resin which is formed by the reaction of an aliphatic polyisocyanate component containing iminooxadiazine dione, isocyanurate, uretdione, urethane, allophanate, biuret and/or oxadiazine trione groups, with an alcohol component containing at least one monobasic, hydroxyl-functional linear or branched alkyl ester of meth(acrylic) acid.

In preferred forms, the first urethane acrylate resin has a molecular weight between about 800 and about 2,500 g/Mol. More preferably, the first acrylated aliphatic urethane has a molecular weight of about 1,000 to about 1,600 g/Mol, with a molecular weight of about 1,400 g/Mol being the most preferred in work to date. The alcohol component used in the formation of the first urethane acrylate resin can have a molecular weight of about 100 to about 2,000 g/Mol. As would be understood, molecular weights for polymerizable resins given herein are number average molecular weights unless specified otherwise. In certain variants, the first urethane acrylate can be the reaction product of:
(a) a polyisocyanate component containing from 20 to 100 mole %, based on the moles of the polyisocyanate component, of iminooxadiazine dione group-containing polyisocyanate trimers encompassed by the formula I:

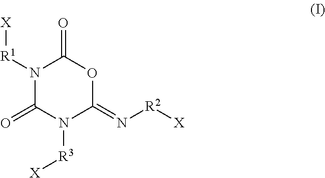

wherein: R¹, R² and R³ of formula I are the same or different and represent linear or branched, C₄-C₂₀ (cyclo)alkyl groups, and X is the same or different and represents isocyanate groups or isocyanate group-containing radicals that also contain iminooxadiazine dione, isocyanurate, uretdione, urethane, allophanate, biuret or oxadiazine trione groups, wherein R¹, R² and R³ of formula I are attached to a nitrogen atom, with (b) an alcohol component containing at least one monobasic, hydroxy-functional, linear or branched C₁-C₁₂ alkyl ester of (meth)acrylic acid. Additional information concerning such urethane acrylate resins suitable for use in the present invention is found in U.S. Pat. No. 6,191,181, which is hereby incorporated herein by reference in its entirety, including for its disclosure of preparative methods and final urethane acrylate resin compounds that can be used in the present invention.

In certain embodiments, the first urethane acrylate has a functionality of about 2 to about 6, more preferably about 3 to about 5, and most preferably about 3.5 to about 4. In addition or alternatively, the first urethane acrylate can exhibit the capacity for ultraviolet radiation curing to provide a hard coating, for example having a pencil hardness above 4, e.g. about 4 to about 7.

The first aliphatic urethane acrylate resin can be provided alone or can be provided admixed with one or more reactive diluents, for example HDDA (1, 6 Hexanediol diacrylate), TPGDA (tripropyleneglycol diacrylate), DPGDA (dipropyleneglycol diacrylate), TMPTA (trimethylolpropane triacrylate), and/or GPTA (glycerolpropoxy triacrylate). When admixed with one or more reactive diluents, the first aliphatic urethane acrylate resin can constitute about 70% to about 90% of the mixture in certain embodiments.

Suitable resins for use as the first urethane acrylate resin include, as examples, Desmolux VP LS2308, Desmolux XP2609, Desmolux LP WDJ 4060 (Bayer Material Science, Pittsburgh PA), and RX5503, RX04788 and IRR 598 (Cytec Surface Specialties, Smyrna, GA).

The present invention is based on a synergistic two-component urethane acrylate system that provides quantifiable improvements in coating performance. This section details the chemical composition, stoichiometric ratios, structure-property relationships, and interaction mechanisms between the first and second aliphatic urethane acrylate components.

The first aliphatic urethane acrylate component can be represented by the general formula:

R₁—[NHCOO—R₂—OOC—C(R₃)═CH₂]ₙ

Where R₁ represents the aliphatic polyisocyanate-derived backbone containing structural elements such as iminooxadiazine dione, isocyanurate, uretdione, urethane, allophanate, biuret, or oxadiazine trione groups; R₂ represents the alcohol component-derived linking group; R₃ represents H (acrylate) or CH₃ (methacrylate); and n represents the functionality, typically ranging from 2 to 8.

The aliphatic polyisocyanate component of the first urethane acrylate can be classified into several precisely defined categories. Aliphatic Diisocyanate-Derived Polyisocyanates (Type A) are based on hexamethylene diisocyanate (HDI), containing 60-100% by weight of isocyanurate groups, with an NCO content of 17-22% by weight and a viscosity at 25° C. of 1,000-5,000 mPa·s. Commercial examples include Desmodur N3300, N3200, and N3600 from Covestro. Aliphatic Diisocyanate-Derived Polyisocyanates (Type B) are based on HDI, containing 40-80% by weight of biuret groups, with an NCO content of 21-24% by weight and a viscosity at 25° C. of 2,500-7,500 mPa·s. Commercial examples include Desmodur N100, N75, and N3200 from Covestro. Cycloaliphatic Polyisocyanates (Type C) are based on isophorone diisocyanate (IPDI), with an NCO content of 11-18% by weight and a viscosity at 25° C. of 2,000-15,000 mPa·s. Commercial examples include Vestanat T1890/100 and Desmodur Z4470 from Evonik/Covestro. Iminooxadiazine Dione-Containing Polyisocyanates (Type D) contain 40-80% by weight of iminooxadiazine dione groups, with an NCO content of 18-23% by weight and a viscosity at 25° C. of 3,000-10,000 mPa·s. Commercial examples include Desmodur VP LS2308 and XP2609 from Covestro. Dimeric Aliphatic Diisocyanates (Type E) are based on uretdione groups (dimerized HDI or IPDI), with an NCO content of 20-32% by weight. Commercial examples include Desmodur N3400 and Vestanat IPDI-DU from Covestro/Evonik.

The alcohol component used in the formation of the first urethane acrylate can be characterized by a hydroxyl value of 100-700 mg KOH/g, a molecular weight of 100-2,000 g/mol, a functionality of 1-4 hydroxyl groups per molecule, and an acrylate group content of 0.5-6.0 mmol/g.

Specific alcohol components include Hydroxyalkyl Acrylates, which comprise 60-100% of the total alcohol component. These include 2-Hydroxyethyl acrylate (HEA), 2-Hydroxypropyl acrylate (HPA), 4-Hydroxybutyl acrylate (HBA), and their corresponding methacrylates (HEMA, HPMA, HBMA). Polyether Polyols may constitute 0-40% of the total alcohol component and include polypropylene glycol (Mn=200-1,000), polyethylene glycol (Mn=200-1,000), and block copolymers of ethylene oxide/propylene oxide (Mn=500-2,000).

Polyester Polyols may represent 0-40% of the total alcohol component and include linear polyester polyols based on adipic acid and 1,6-hexanediol (Mn=500-2,000), as well as branched polyester polyols based on phthalic anhydride and trimethylolpropane (Mn=500-1,500). Polycarbonate Polyols may comprise 0-30% of the total alcohol component and include linear polycarbonate diols (Mn=500-2,000) and branched polycarbonate polyols (Mn=800-1,500).

The stoichiometric ratio of NCO:OH during the synthesis of the first urethane acrylate component is important for controlling properties. A ratio of NCO:OH from 1.0:1.0 to 1.05:1.0 results in complete conversion with minimal free NCO. A ratio of NCO:OH from 1.1:1.0 to 1.3:1.0 provides moderate excess NCO and enhanced reactivity. A ratio of NCO:OH from 1.5:1.0 to 2.0:1.0 results in high excess NCO and requires quenching with monofunctional alcohols.

The second aliphatic urethane acrylate component can be represented by the general formula:

[CH₂═C(R₃)—COO—R₄]ₘ—[OCNH—R₅—NHCOO—R₆—OCO—R₇]ₚ—[OCNH—R₅—NHCO—R₈]q

Where R₃ represents H (acrylate) or CH₃ (methacrylate); R₄ represents the spacer group derived from multifunctional acrylate; R₅ represents the alkyl carbomoncycle diisocyanate-derived group; R₆ represents the polyol-derived linking group; R₇ and R₈ represent acrylate-functional end groups or chain extender-derived groups; and m, p, q represent the degree of polymerization of each segment.

The alkyl carbomoncycle diisocyanate component can be precisely defined as follows. 4,4′-Methylenebis (cyclohexyl isocyanate) (H₁₂MDI) has an isomer ratio of 20-80% trans,trans, 20-80% cis,trans, and 0-20% cis,cis, with an NCO content of 31.5-32.0% by weight. Commercial examples include Desmodur W and Hylene W. Isophorone Diisocyanate (IPDI) has an isomer ratio of 70-75% trans and 25-30% cis, with an NCO content of 37.5-38.0% by weight. 1,3-Bis(isocyanatomethyl cyclohexane (H₆XDI) has an NCO content of 39.0-40.0% by weight. 4,4′-Diisocyanatodicyclohexylmethane has an NCO content of 31.0-32.0% by weight.

The multifunctional acrylate component used in forming the second urethane acrylate can be categorized as follows. Di-and Tri-functional Acrylates include trimethylolpropane triacrylate (TMPTA), pentaerythritol triacrylate (PETA), 1,6-hexanediol diacrylate (HDDA), and dipentaerythritol pentaacrylate (DPEPA), with a molecular weight of 170-500 g/mol and an acrylate equivalent weight of 85-250 g/mol. Alkoxylated Multifunctional Acrylates include ethoxylated trimethylolpropane triacrylate (3-15 EO units) and propoxylated glycerol triacrylate (3-15 PO units), with a molecular weight of 400-1,000 g/mol and an acrylate equivalent weight of 150-450 g/mol.

The polyol component used in the formation of the second urethane acrylate typically comprises Polycarbonate Polyols, which are linear polycarbonate diols based on 1,6-hexanediol with a molecular weight of 500-2,000 g/mol and a hydroxyl value of 56-225 mg KOH/g. Polyester Polyols include adipic acid-based polyester polyols with a molecular weight of 500-2,000 g/mol and a hydroxyl value of 56-225 mg KOH/g. Polyether Polyols include polypropylene glycol and polytetramethylene glycol with a molecular weight of 650-2,000 g/mol and a hydroxyl value of 56-170 mg KOH/g.

The synergistic effects observed in the two-component system arise from specific molecular interactions that can be quantified. Hydrogen Bonding Interactions involve urethane N—H groups (donor) interacting with carbonyl groups (acceptor) from both components and ether linkages (acceptor) from both components. The bond strength ranges from 2-8 kcal/mol per hydrogen bond, with a density of H-bonding sites of 0.5-2.5 mmol/g.

Phase Separation Morphology is characterized by micro-domain sizes of 5-50 nm, interfacial thickness of 2-10 nm, and domain composition ratios of 30:70 to 70:30 (First:Second component). Crosslink Density Gradients feature core crosslink density of 0.1-0.5 mol/cm³, shell crosslink density of 0.05-0.2 mol/cm³, and gradient steepness factors of 0.1-0.8 (dimensionless). Network Interpenetration is characterized by a degree of interpenetration of 10-80%, network mesh size of 5-50 Å, and entanglement density of 0.05-0.5 mol/cm³.

The optimized weight ratios between first and second urethane acrylate components for specific automotive applications are as follows. For Headlamp Lens Coatings, the First:Second component ratio ranges from 1:2 to 1:5, with a total urethane acrylate content of 35-65% by weight of total formulation, and optimal synergistic performance at a ratio of 1:3.5±0.5. For Signal Lamp Lens Coatings, the First:Second component ratio ranges from 1:1 to 1:3, with a total urethane acrylate content of 40-70% by weight of total formulation, and optimal synergistic performance at a ratio of 1:2±0.3.

For Interior Trim Coatings, the First:Second component ratio ranges from 1:1 to 3:1, with a total urethane acrylate content of 30-60% by weight of total formulation, and optimal synergistic performance at a ratio of 2:1±0.3. For Exterior Trim Coatings, the First:Second component ratio ranges from 1:2 to 1:4, with a total urethane acrylate content of 40-70% by weight of total formulation, and optimal synergistic performance at a ratio of 1:3±0.4.

The chemical interaction between the first and second urethane acrylate components during cure creates unique network architectures that can be characterized by Network Topology Parameters. These include junction functionality of 3-8 (average), elastically active chain concentration of 0.1-1.0 mol/L, cycle rank of 0.5-3.0 (dimensionless), and phantom network modulus of 0.5-5.0 MPa. Viscoelastic Properties include storage modulus (E′) at 25° C. of 1,000-3,500 MPa, loss modulus (E″) at 25° C. of 50-300 MPa, tan δ at 25° C. of 0.03-0.15, and glass transition temperature of 70-140° C.

Cure Kinetics Parameters include activation energy of 50-80 kJ/mol, pre-exponential factor of 10⁻⁶-10⁻⁹ s⁻¹, reaction order of 1.2-2.0, inhibition period of 0.1-5.0 seconds, and maximum cure rate of 0.1-1.0 s⁻¹.

The molecular weight distribution parameters of the first and second urethane acrylate components significantly impact coating performance. For the First Urethane Acrylate, the number average molecular weight (Mn) ranges from 800-2,500 g/mol, the weight average molecular weight (Mw) ranges from 1,000-4,000 g/mol, the polydispersity index (PDI) ranges from 1.1-2.0, and the optimal performance range is an Mn of 1,200-1,600 g/mol. For the Second Urethane Acrylate, the number average molecular weight (Mn) ranges from 500-2,000 g/mol, the weight average molecular weight (Mw) ranges from 800-3,500 g/mol, the polydispersity index (PDI) ranges from 1.2-2.2, and the optimal performance range is an Mn of 700-1,100 g/mol.

The acrylate functionality distribution also plays an important role in coating performance. For the First Urethane Acrylate, the average functionality ranges from 3.0-5.0. The functionality distribution includes 5-25% with 2 functional groups, 20-50% with 3 functional groups, 20-50% with 4 functional groups, and 0-25% with 5 or more functional groups. The optimal average functionality is 3.8-4.2. For the Second Urethane Acrylate, the average functionality ranges from 4.0-8.0. The functionality distribution includes 0-10% with 3 functional groups, 10-30% with 4 functional groups, 20-40% with 5 functional groups, and 30-70% with 6 or more functional groups. The optimal average functionality is 5.5-6.5.

### Structure-Property Relationships in the Two-Component System

Specific quantifiable structure-property relationships have been identified in the two-component urethane acrylate system. For Pencil Hardness (H) vs. Crosslink Density (ρx), the relationship is expressed as H=2.5+8.5·(ρx)\hat{ }0.6, where ρx is in mol/dm³. This is valid for a range of ρx from 0.1-1.0 mol/dm³, with a correlation coefficient (r²) of 0.92.

For Abrasion Resistance (AR) vs. Component Ratio (CR), the relationship is expressed as AR=95—30·|CR−0.29|\hat{ }0.8, where CR is the weight fraction of the first component. This is valid for a range of CR from 0.1-0.5, with a correlation coefficient (r²) of 0.88.

For UV Stability (UVS) vs. Urethane Content (UC), the relationship is expressed as UVS=75+45·(UC)\hat{ }0.5−25·(UC)², where UC is in mmol/g. This is valid for a range of UC from 0.5-3.0 mmol/g, with a correlation coefficient (r²) of 0.85.

For Chemical Resistance (CR) vs. Network Parameters, the relationship is expressed as CR=65 +20·log(ρx)+15·(HC)\hat{ }0.7, where ρx is crosslink density and HC is hydrogen bond concentration. This is valid for ranges of ρx from 0.1-1.0 mol/dm³ and HC from 0.5-2.5 mmol/g, with a correlation coefficient (r²) of 0.90.

The optimal ratio of first to second urethane acrylate components has been determined to follow a non-linear relationship that can be expressed as:

$$R *= a \cdot {( T 1 / T 2 )}^{⋀} b \cdot {( F 1 / F 2 )}^{⋀} c \cdot {( M 1 / M 2 )}^{⋀} d$$

Where R* is the optimal weight ratio; T1 and T2 are the glass transition temperatures of components 1 and 2; F1 and F2 are the functionalities of components 1 and 2; M1 and M2 are the molecular weights of components 1 and 2; and the constants are a=2.5±0.3, b=0.4±0.1, c=−0.6±0.1, and d=0.3±0.1. This relationship allows for precise formulation optimization based on the specific properties of the urethane acrylate components selected.

In certain embodiments, the coating compositions of the invention also include a second urethane acrylate resin different from the first urethane acrylate resin. The second urethane acrylate resin can be formed by the reaction of a multifunctional acrylate (e.g. with a molecular weight of about 190 to about 500 and containing at least three polymerizable unsaturated groups per molecule) with an aliphatic urethane based on a polymer of alkyl carbomoncycle diisocyanate with alkanepolyol polyacrylates. In certain embodiments, the second urethane acrylate resin is encompassed by the formula II:

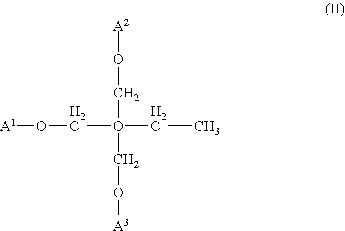

wherein A¹, A², and A³ are each a group of the formula III:

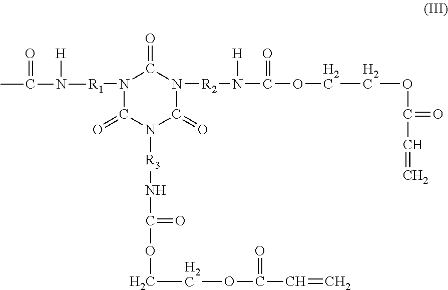

wherein R¹, R², and R³ of formula III, which can be the same or different, are each a linear aliphatic group having from 2 to about 12 carbon atoms, or a cycloaliphatic group having from 4 to about 12 carbon atoms. R¹, R², and R³ of formula III are each preferably an alkylene group having from 2 to about 12 carbon atoms. Compounds of Formula II can be prepared, for example, as described in U.S. Pat. No. 5,658,672, which is hereby incorporated herein by reference in its entirety, including for its disclosure of preparative methods and of final compounds encompassed by formula II above that may be used in the present invention. This '672 patent teaches that Ebecryl 8301 is a blend including a diluent and a hexafunctional acrylate oligomer according to formula II in a weight ratio of about 48:52, respectively, with the diluent being (ethylene-/diethylene glycol diacrylate (based on hydroxyethylacrylate), mostly ethylene glycol diacrylate.

Preferably, the second urethane acrylate resin has a molecular weight in the range of about 500 to about 2000 g/Mol, more preferably about 800 to about 1000 g/Mol, and most preferably to date about 800 g/Mol. In certain embodiments, the second urethane acrylate has a functionality of about 2 to about 10, more preferably about 4 to about 8, and most preferably about 6. Suitable resins for use as this second urethane acrylate resin include, as examples, Ebecryl 8301, Ebecryl 1290, Ebecryl 5129 (Cytec Surface Specialties, Smyrna, GA), Ebecryl 1290K, (Diacel-Cytec Company Ltd, Tokyo, Japan) and CN968 (Sartomer Company, Exton, PA).

As disclosed above, certain embodiments of the invention relate to coating compositions which include a blend of resins including a first urethane acrylate resin as discussed above and a second urethane acrylate resin as discussed above. In preferred such embodiments, exclusive of any inert solvent present in the composition, the first urethane acrylate resin constitutes about 10% to about 40% by weight of the composition. More preferably in such embodiments, exclusive of any inert solvent present, the first urethane acrylate resin makes up about 10% to about 30% of the composition, even more preferably about 15 to about 25%. As to the second urethane acrylate resin, exclusive of any solvent present, it preferably constitutes about 20% to about 50% by weight of the coating composition, more preferably about 25 to 35%.

In other embodiments of the invention defined herein, the first and second urethane acrylate resins are included in the coating composition in a weight ratio, or in a molecular ratio, of about 1:10 to about 10:1, respectively, more preferably about 1:5 to 5:1, and most preferably about 1:3 to about 3:1. In certain specified embodiments, the first and second urethane acrylate resins will be present in a weight ratio, or in a molecular ratio, of about 1:2 to about 2:1, respectively.

When included in a blended resin coating composition, the first and second urethane acrylate resins can provide preferred compositions which form UV-cured coatings of with a high degree of surface hardness as measured with steel wool per FMVSS108 and taber abrasion per ASTM D1044. Additionally, preferred blended coatings including these urethane acrylates provide excellent weathering properties as quantified by well accepted accelerated and natural weathering test methods and thermal crack resistance. Also, they offer advantageous curing rates and material compatibility.

The surface hardness of resin blend coating compositions as disclosed herein can be further improved with the addition of an acrylated organic-inorganic hybrid material, typically produced through a sol gel process. The preferred organic-inorganic hybrid is comprised of silica particles in the range of about 5 nm to about 100 nm that are spherical, non-porous and amorphous and a multifunctional acrylate with a molecular weight of about 200 to about 450 and at least two polymerizable unsaturated groups per molecule. The preferred final molecular weight the organic-inorganic hybrid is between about 500 and about 3000. Improved surface hardness properties can be achieved with additions of about 5% to about 35% by weight (exclusive of any inert solvent present) of such acrylated organic-inorganic hybrid materials. More preferably the content of the acrylated organic-inorganic hybrid, when included, is about 8% to about 18% by weight, exclusive of any inert solvent present. Examples of suitable organic-inorganic materials that can be used in compositions, coatings and coated articles of the invention include Etercure 601A-35, Etercure 601B-35, Etercure 601C-35, Etercure 601H-35, (Eternal Chemical Company, Ltd, Taiwan) and RX11402 (Cytec Surface Specialties, Smyrna, GA)

The coating compositions of the present invention can incorporate advanced photoinitiator systems. These enhanced systems provide improved curing efficiency, depth of cure, and final coating properties.

The invention encompasses hybrid photoinitiator systems that combine different photoinitiator classes to achieve synergistic effects. Type I/Type II hybrid systems combine alpha-cleavage (Type I) photoinitiators such as acylphosphine oxides with hydrogen abstraction (Type II) photoinitiators such as benzophenones or thioxanthones. These hybrid systems provide more efficient curing across a broader UV wavelength range and can reduce oxygen inhibition effects, resulting in improved surface cure properties. For example, a combination of bis-2,4,6-trimethylbenzoylphenylphosphine oxide with a difunctional α-hydroxy-cyclohexyl-phenyl-ketone can provide exceptional curing efficiency with reduced surface tackiness.

Multifunctional photoinitiators represent another advancement incorporated in the present invention. In certain embodiments, these novel structures contain both photoinitiating moieties and reactive groups (such as acrylate or methacrylate functionalities) that become chemically incorporated into the polymer network during curing. This approach eliminates photoinitiator migration and extraction issues while potentially improving weatherability. By becoming chemically bound to the coating matrix, these photoinitiators cannot leach out over time, resulting in improved long-term performance.

Nanoparticle-bound photoinitiators can also be incorporated in the present invention. These consist of photoinitiator molecules chemically bound to nanoparticles (such as silica or titanium dioxide), providing improved dispersion, reduced migration, and potential for improved depth of cure. The nanoparticle carriers can also contribute to enhanced mechanical properties of the final coating.

The invention also encompasses advanced initiator systems with controlled activation mechanisms. Photolatent initiators remain dormant until exposed to specific triggering conditions (such as particular wavelengths or sequential exposures), enabling better control over the curing process. This can be particularly valuable for complex three-dimensional parts where controlled curing progression is desired.

Thermally activated co-initiators can be incorporated to create systems that combine UV photoinitiators with thermally activated components, enabling dual-cure mechanisms that ensure complete polymerization even in shadowed areas. This approach is particularly valuable for complex geometries where UV light penetration may be limited.

Redox-activated systems that can be activated through both photochemical and redox pathways provide versatility in curing options and can be useful for ensuring complete cure in thick films or complex parts.

For applications requiring reduced VOC content or compatibility with water-based systems, the invention encompasses water-dispersible photoinitiator formulations containing specially modified photoinitiators with hydrophilic groups that enable dispersion in aqueous systems without compromising curing efficiency. Emulsified photoinitiator systems consisting of microemulsions or nanoemulsions of conventional photoinitiators in water, stabilized by surfactants, can also be employed.

With the growing importance of LED curing technology, the invention encompasses photoinitiators specifically optimized for LED curing sources. Visible light photoinitiators with absorption maxima matched to specific LED wavelengths (such as 365, 385, 395, or 405 nm) ensure efficient energy utilization and complete curing. Sensitized photoinitiator systems, which combine photoinitiators with sensitizers that extend absorption ranges to better match LED emission profiles, provide enhanced curing efficiency with LED sources. Modified acylphosphine oxide photoinitiators with absorption properties optimized for LED curing sources represent another advancement incorporated in the present invention.

The invention also encompasses initiator systems that enable multiple curing mechanisms. UV+moisture cure systems combine photoinitiators with moisture-reactive components (such as silane or isocyanate functionalities) to ensure complete curing even in shadowed areas. UV+thermal cure systems incorporate both photoinitiators and thermal initiators (such as peroxides) to enable sequential or simultaneous curing by different energy sources. Photo-redox systems combine photochemical and redox polymerization mechanisms for improved cure in thick films or complex geometries.

Many photoinitiators and/or sensitizers are suitable for use in coating compositions of the invention. Among the groups of suitable photoinitiators are diphenylphosphine oxide type photoinitiators such as 2,4,6-trimethylbenzoyl diphenylphosphine oxide and bis-2,4,6-trimethylbenzoylphenylphosphine oxide; phenylglyoxylate type such as oxy-phenyl-acetic acid 2-[2 oxo-2 phenyl-acetoxy-ethoxy]-ethy ester and oxy-phenyl-acetic 2-[2-hydroxy-ethoxy]-ethyl ester; α-hydroxyketone type such as 1-hydroxy-cyclohexyl-phenyl-ketone, 2-hydroxy-1-[4-(2-hydroxyethoxy) phenyl]-2-methyl-1-propanone, 2-hydroxy-2-methyl-1-pheyl-1-propanone, and difunctional α-hydoxyketones. The preferred embodiment includes a blend of diphenylphosphine oxide and α-hydroxyketone type photoinitiators with a more preferred blend of bis-2,4,6-trimethylbenzolydiphenylphosphine oxide and difunctional α-hydroxy-cyclohexyl-phenyl-ketone.

At least one photoinitiator is preferably added to the preferred formulations in amounts sufficient to obtain the desired cure response. In preferred formulations of the invention, a blend of at least two photoinitiators is included in amounts of about 0.25% to about 15% by weight. The range of the first preferred photoinitiator (a diphenylphosphine oxide type as noted above) is about 0.5% to about 2.5% in certain embodiments. The range of the second preferred photoinitiator (an α-hydroxyketone type as noted above) is about 4% to about 13% in certain embodiments. In certain inventive formulations, a further benefit is gained by the addition of a third photoinitiator, for example a hydroxyalkylphenone type photoinitiator, in the range of about 0.5% to about 4.5%. The amounts of photoinitiator(s) included will vary based upon many factors such as the types of UV cure equipment, the UV equipment set up, cure rate and durability desired.

The coating compositions of the present invention can be applied to a broader range of substrates and used in diverse applications beyond the vehicle forward lighting lenses.

The coating compositions are particularly suitable for application to various optical components, including display technologies such as touchscreens, LCD/OLED display covers, and flexible display substrates where a combination of optical clarity, scratch resistance, and flexibility is required. Optical filters and lenses for photographic, medical, and industrial applications can benefit from the enhanced durability provided by these coatings without compromising optical performance. Augmented and virtual reality (AR/VR) components, including visor materials, waveguides, and other optical elements used in AR/VR devices can be coated with these compositions to provide optical clarity, scratch resistance, and lightweight properties critical for these applications. Optical sensors, including camera lenses, LiDAR components, and other sensor covers used in autonomous vehicles, drones, and security systems can also be protected with these coating compositions.

In architectural applications, the coating compositions can be used as protective coatings for polycarbonate or acrylic glazing panels used in skylights, canopies, and similar applications where UV resistance and durability are essential. Polymer-based facade elements and decorative cladding materials can be protected from environmental degradation with these coatings. Interior architectural elements, including decorative panels, partitions, and signage, can benefit from the scratch resistance and aesthetic durability provided by these compositions. Urban furniture components exposed to harsh environmental conditions and vandalism can be effectively protected using these coating compositions.

In the medical field, the coating compositions are suitable for diagnostic equipment housings, providing chemical resistance against disinfectants and cleaning agents while maintaining optical clarity where needed. Fluid management components, including connectors, viewing windows, and flow cells, can benefit from the chemical resistance and optical clarity provided by these coatings. Non-implantable portions or external accessories of medical devices can be coated with these compositions to provide biocompatibility and durability. Laboratory equipment, including sample containers, analysis chambers, and optical components used in diagnostic and research equipment, can also benefit from these protective coatings.

For electronic components and assemblies, the coating compositions can provide scratch resistance and durability for touch interfaces and control surfaces. LED lighting components, including diffusers, lenses, and reflectors, can be protected with these compositions. Electronic device housings can be coated to prevent scratching, chemical exposure, and UV degradation. Photovoltaic components, including protective covers for solar cells and related sensing equipment, can also benefit from these protective coatings.

In additive manufacturing applications, the coating compositions can provide improved surface properties, including scratch resistance, chemical resistance, and UV stability to 3D printed components that would otherwise have limited durability. The compositions can be modified for direct 3D printing applications, including stereolithography (SLA), digital light processing (DLP), and inkjet-based 3D printing technologies. They can also be used in hybrid manufacturing processes that combine traditional manufacturing with additive techniques. 3D printed prototypes can better simulate the properties of final production parts through the application of these protective coatings.

Consumer goods applications include eyewear such as sunglasses, prescription lenses, and safety eyewear; sporting equipment such as visors, shields, and viewing panels; home appliances including display covers, control panels, and decorative elements; and personal electronic devices including screen protectors, camera lens covers, and decorative elements.

The coating compositions of the present invention can incorporate a variety of performance enhancement additives to achieve specific property improvements.

Beyond the sol-gel hybrid materials described herein, the invention encompasses additional nanotechnology components. Engineered nanoparticles including nano-silica (5-150 nm) with various surface modifications can enhance compatibility and performance. Nano-alumina can be incorporated for improved abrasion resistance, while nano-zirconia can provide refractive index modification and hardness enhancement. Nano-ceria offers UV absorption and catalytic properties, and nano-zinc oxide and nano-titanium dioxide with surface modifications can provide UV absorption without photocatalytic activity.

Carbon-based nanomaterials can also be incorporated in the coating compositions. Graphene and graphene oxide at concentrations of 0.01-2.0% can provide improved barrier properties, thermal conductivity, and mechanical reinforcement. Carbon nanotubes (single or multi-walled) at concentrations of 0.01-1.0% can contribute electrical conductivity, mechanical reinforcement, and potential self-healing properties. Fullerenes and their derivatives can function as radical scavengers and improve weatherability.

Core-shell nanoparticles represent another advancement incorporated in the present invention. These engineered nanoparticles with core-shell structures feature a core that provides specific functional properties while the shell ensures compatibility with the coating matrix. Examples include silica-polymer core-shell nanoparticles, metal-silica core-shell structures, and multilayered nanoparticles.

Quantum dots and plasmonic nanoparticles can be incorporated for specific optical properties, including selective light absorption or emission, with applications in security features and specialized optical coatings.

The invention encompasses advanced light stabilization systems. Synergistic stabilizer packages consisting of optimized combinations of UV absorbers, HALS, and antioxidants can provide synergistic protection targeted at specific degradation mechanisms relevant to different application environments. Reactive UV stabilizers, including UV absorbers and HALS with reactive functionalities (such as acrylate or methacrylate groups), become chemically bound to the polymer matrix during curing. This approach prevents migration and extraction of the stabilizers, providing long-term protection even under harsh conditions.

Encapsulated stabilizer systems, where UV absorbers and HALS are encapsulated in micro or nanocapsules for controlled release over time, provide extended protection and reduce initial blooming issues. Red-shifted UV absorbers with absorption extending into the visible region protect against longer wavelength radiation, which is particularly valuable for applications with exposure to harsh lighting conditions.

Surface-modifying additives can be incorporated to provide specialized surface properties. Anti-scratch nanocomposites, consisting of hybrid organic-inorganic nanocomposites specifically designed for improved scratch resistance, incorporate interpenetrating networks of inorganic and organic components at the nanoscale. Anti-fog additives, including hydrophilic components that prevent fog formation by ensuring that condensed water forms a transparent film rather than droplets, can be incorporated for applications where optical clarity must be maintained under varying humidity conditions. Anti-fingerprint additives, including fluorinated compounds and silicone derivatives, reduce the visibility of fingerprints and include oleophobic and hydrophobic surface modifiers that make cleaning easier. Anti-static additives, including conductive nanoparticles or polymers that dissipate static charge, can be incorporated for applications where static electricity accumulation is problematic.

Self-healing components represent another advancement incorporated in the present invention. Microcapsule-based healing systems containing reactive healing agents that release upon damage can provide automatic repair of minor scratches and defects. Systems based on reversible chemistry, where components form reversible chemical bonds (such as Diels-Alder adducts) that can reform after breaking, can repair damage upon exposure to specific stimuli such as heat. Phase-separated healing additives that form a separate phase within the coating and can flow into damaged areas when damage occurs include supramolecular polymers and materials with physical crosslinks. Shape memory components that impart shape memory properties to the coating enable it to return to its original state after deformation.

Antimicrobial additives can also be incorporated in coating compositions of the present invention. Silver-based antimicrobials, including silver nanoparticles and silver ion-exchange compounds, provide controlled-release antimicrobial action. Surface-bound quaternary ammonium compounds provide contact-killing antimicrobial properties and can be chemically incorporated into the coating matrix during curing. Metal oxide antimicrobials, including zinc oxide, copper oxide, and other metal oxides with antimicrobial properties, can be incorporated in surface-modified versions to ensure compatibility with the coating system. Natural antimicrobial compounds, including plant-derived antimicrobial compounds and peptide-based antimicrobials, provide environmentally friendly alternatives for antimicrobial protection.

Preferred coating compositions of the invention also include stabilizing materials to maximize exterior durability and UV resistance. Suitable stabilizers include hindered amines and UV absorbers such as benzotriazole or benzotriazine derivatives. The amount of stabilizers in the system vary depending on application parameters and desired performance properties to maximize weatherability without sacrificing cure response and surface hardness. In more preferred compositions, the hindered amine is in the range of about 0.5% to about 4.5%, hydroxyphenyl benzotriazine (or other suitable compound) is in the range of about 2% to about 15% and an antioxidant is in the range of about 0.25% to about 2.0%.

Preferred coating compositions of the invention include one or more inert solvents. In certain embodiments, the compositions include a blend of inert solvents. Examples of suitable inert solvents include ester solvents such as ethyl acetate and butyl acetate; ketone solvents such as acetone and methyl ethyl ketone; alcohol solvents such as isopropyl alcohol and secondary butyl alcohol. The amount and type of solvent in the composition will vary depending on application method and equipment capabilities and preference. For example, in a flowcoat or curtain coat application, inert solvents should not be excessively aggressive to the base plastic of the molded article. In certain forms of the invention, the inert solvent content in the coating composition as a whole can range from 0% to 80% by weight with a preferred solvent content of 35% to 65% by weight.

Various other additives can also be included in coating compositions of the invention to further improve appearance and/or performance properties of the cured coating. Examples of suitable additives are reactive and non-reactive acrylic or silicone flow, slip and mar and leveling agents that assist in substrate wetting and leveling of the composition and phenolic based antioxidants that provide thermal and process stability. One particularly preferred additive is a polysilixoane solution, such as that commercially available under the tradename Byk 301 (BYK-CHEMIE, Wallingford, CT).

In certain preferred embodiments, a resin blend coating composition is provided that includes an inert organic solvent in an amount of about 10-50% by weight, a first aliphatic urethane acrylate as discussed above in an amount of about 3% to about 20% by weight, a second aliphatic urethane acrylate as discussed above in an amount of about 3% to about 20% by weight, a reactive diluent component in an amount of about 5% to about 30% by weight wherein the reactive diluent component includes one or more multifunctional acrylates, one or more photoinitiators, e.g. selected from those identified herein, and one or more light stabilizers, e.g. selected from those identified herein. More preferred compositions of this embodiment further include an antioxidant and a flow additive, e.g. as identified herein. In certain forms, in the preparation of the first aliphatic urethane acrylate, X of Formula I represents isocyanate groups. In other preferred compositions of this embodiment, X of Formula I represents isocyanate group-containing radicals that also contain iminooxadiazine dione groups; or X of Formula I represents isocyanate group-containing radicals that also contain isocyanurate groups; or X of Formula I represents isocyanate group-containing radicals that also contain uretdione groups; or X of Formula I represents isocyanate group-containing radicals that also contain urethane groups; or X of Formula I represents isocyanate group-containing radicals that also contain allophanate groups; or X of Formula I represents isocyanate group-containing radicals that also contain biuret groups; or X of Formula I represents isocyanate group-containing radicals that also contain oxadiazine trione groups. In these embodiments, the first aliphatic urethane acrylate, and the second aliphatic urethane acrylate, may also have any of the other characterizing features as disclosed herein.

The coating compositions of the present invention can be applied and cured using a variety of advanced process technologies.

The invention encompasses adapted formulations and processes for energy-efficient curing. LED UV curing technology represents a significant advancement incorporated in the present invention. Formulations specifically optimized for LED UV sources with narrow emission bands (typically centered at 365, 385, 395, or 405 nm) contain photoinitiators and sensitizers with absorption spectra matched to LED emission profiles. Benefits of LED UV curing include reduced energy consumption, longer equipment lifetime, reduced heat generation, and elimination of mercury concerns associated with traditional mercury vapor lamps. Low-energy electron beam (EB) curing can also be employed with formulations suitable for curing with low-voltage electron beam systems (below 100 kV). These formulations do not require photoinitiators, resulting in improved weatherability and reduced yellowing. EB curing offers advantages for thick films and can cure compositions that are highly pigmented or contain UV-blocking additives.

Variable power curing processes can be employed with the coating compositions of the present invention. These multi-stage curing processes perform initial curing at low intensity to reduce shrinkage stress, followed by higher intensity curing to complete polymerization. This approach reduces defects such as wrinkling, orange peel, and delamination that can result from excessive shrinkage stress during rapid curing. Pulsed light curing using high-intensity pulsed light sources rather than continuous exposure can provide more efficient energy use and improved curing of thick films.

The invention encompasses formulations designed for multiple curing mechanisms. UV-thermal dual cure systems contain both photoinitiators and thermal initiators, where UV curing provides rapid initial setting while thermal curing ensures complete polymerization in shadowed areas. This approach is particularly valuable for complex three-dimensional parts where UV light penetration may be limited. UV-moisture dual cure systems contain both UV-curable components and moisture-reactive functionalities (such as silane or isocyanate groups), where UV curing provides rapid surface cure while moisture curing continues over time to develop full properties. UV-oxidative dual cure systems contain both UV-curable acrylate functionalities and oxidative curing components (such as alkyds or polyunsaturated oils), combining the rapid cure of UV systems with the self-healing characteristics of oxidative cure systems. Sequential curing processes using multi-layer or multi-component systems where different curing mechanisms are activated in sequence allow for complex material architectures with gradient properties.

The invention encompasses processes using modified atmospheric conditions during curing. Inert atmosphere curing conducted under nitrogen, argon, or carbon dioxide atmospheres eliminates oxygen inhibition, enabling more complete surface cure, improved gloss, and potentially reduced photoinitiator levels. Controlled humidity curing, where humidity levels are precisely controlled during curing, can optimize properties, particularly for dual-cure systems with moisture-curing components. Vacuum-assisted curing conducted under partial vacuum can remove volatile components and reduce bubbles, which is valuable for thick films and applications requiring exceptional optical clarity. Pressurized curing conducted under elevated pressure can reduce the impact of volatile components and improve interphase formation in nanocomposite formulations, enhancing mechanical properties and adhesion.

The invention encompasses formulations optimized for advanced application technologies. Precision spray technologies, including high-volume, low-pressure (HVLP) spray systems, electrostatic spray application, and ultrasonic spray technologies, can provide improved material efficiency, coverage of complex shapes, and ultra-thin, defect-free coatings. Integration with additive manufacturing technologies, including direct integration with 3D printing technologies such as inkjet-based systems and stereolithography, enables new manufacturing approaches. Digital coating technologies, including formulations suitable for inkjet and other digital dispensing technologies, enable precise patterning and variable coating properties across a single substrate. Advanced roller coating technologies, including micro-gravure and other precision roller coating technologies, can provide thin, uniform films at high production speeds.

The invention also encompasses formulations and processes for in-mold decoration. In-mold coating (IMC) formulations are suitable for application directly in the mold during molding of plastic components, eliminating the need for post-molding coating operations. Film insert molding (FIM) uses pre-coated films that are formed and then incorporated into the molding process, where the coating provides enhanced surface properties to the molded part. In-mold labeling with functional coatings incorporates labels with functional coatings into molded parts, providing areas with specific surface properties. In-mold electronics (IME) integrates the coating process with in-mold electronics technologies to create parts with embedded electronic functionality and durable surfaces.

Coating compositions of the invention can be applied to a selected article by various conventional coating methods such as conventional spray, HVLP spray, air assisted/airless spray, rotary atomization, flowcoat, curtain coat or rollcoat. Further, the coating compositions can be applied directly to the substrate or over a previously-cured or uncured coating. The desired film thickness of the cured film formed with coating compositions of the invention is about 3 microns to about 40 microns with the most preferred dry film thickness being about 5 microns to about 20 microns.

Once applied, the coating composition can be cured by irradiation with ultraviolet energy as is known to those skilled in the art. In this regard, the irradiation is continued until curing is complete, with preferred exposure times typically being less than 300 seconds and more preferably about 20 to about 100 seconds. Curing temperatures can range from room temperature to the heat distortion temperature of the substrate, while curing distances are typically between about 2 and 18 inches from the UV source achieving a minimum of about 100 mW/cm² of intensity.

An ultraviolet light source having a wavelength range of between about 180 nanometers and 450 nanometers is preferred for curing the topcoat. Acceptable light sources that emit ultraviolet energy include sunlight, sun lamps, LED lamps, carbon or xenon arc lamps, and mercury vapor lamps. More preferred examples of suitable light sources include electrode type arc lamps or electrodeless type microwave lamps equipped with mercury vapor type or metal halide type bulbs that provide strong UV energy output in the aforementioned range.

The most preferred irradiation is achieved through a series of medium to high pressure mercury lamps having an intensity of about 100 W/in to about 600 W/in and provides about 1500 to about 15000 mJ/cm² of UV energy in about 20 to about 75 seconds of exposure when measured with a suitable compact radiometer. More preferred energy outputs are about 3000 to about 8000 mJ/cm². It should be noted that intensity and energy measurement equipment vary depending on the bandwidths that they measure. When the aforementioned preferred coating compositions are processed under these described irradiation conditions, the final coatings provide a unique blend of properties that adequately protect the molded plastic article from environmental and chemical degradation under severe exposure conditions.

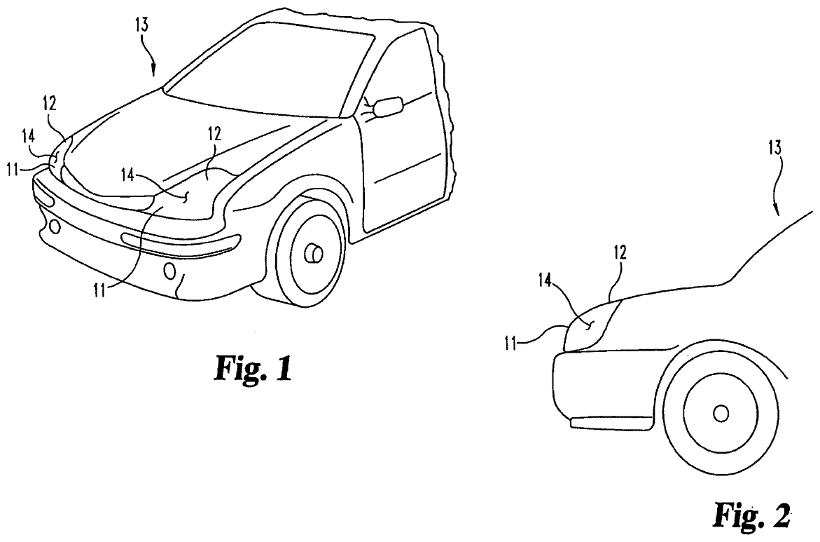

In certain embodiments of the invention, coating compositions as described herein are used to form a coated article, especially a coated plastic article such as one made with polycarbonate or polyester. Preferred embodiments provide coated plastic lenses, and in particular forms coated, clear plastic lenses such as vehicle forward lighting lenses, e.g. made with polycarbonate. In this regard, with reference to FIGS. 1 and 2, shown is one embodiment of a coated vehicle forward lighting lens. Lens 11 is illustrative of a “wrapped lighting” lens in which the lens includes a significant upper component 12 that occurs in a non-vertical orientation (e.g. including at least about 10% of the total external surface area of the lens) and is designed into the hoodline of the vehicle 13, and thus is more directly exposed to incident radiation from sunlight. Such wrapped lenses have become common in current vehicles, and present challenges for coatings designed to provide UV protection to prevent yellowing due to sun exposure. In preferred inventive embodiments, the exterior surface 14 of the lens 11, including the exterior surface of the upper component 12, is topcoated with a UV-cured, clear coating composition of the invention. Additional embodiments of the present invention thus provide such coated forward vehicle lighting lenses as well as vehicles including them.

For the purpose of promoting a further understanding of the invention and certain embodiments thereof, the following Examples are provided. It will be understood that these Examples are illustrative, and not limiting, in nature.

### Example 1 Preparation of UV Curable Blend Compositions

The components listed in Table 1 are combined using known techniques to form a UV curable resin blend composition including amounts of the first and second urethane acrylate resins as described hereinabove, along with multifunctional acrylates, photoinitiators, light stabilizers, an antioxidant and a flow improver. One or more inert solvents as described above can be included in the composition to alter its flow properties.

TABLE 1
Components and Weight Percentages

| | Weight Percent |
|---|---|
| | (exclusive of |
| Component: | solvent) |
| First Urethane | 10-40% |
| Acrylate Resin | |
| Second Urethane | 20-50% |
| Acrylate Resin | |
| Multifunctional | 5-55% |
| Acrylate #1 | |
| (functionality = 2) | |
| Multifunctional | 5-55% |
| Acrylate #2 | |
| (functionality = 3) | |
| Photoinitiator #1 | 0.25-2.5% |
| Photoinitiator #2 | 4-9% |
| Photoinitiator #3 | 0.5-4% |
| Hindered Amine Light | 0.5-4.5% |
| Stabilizer | |
| Benzotriazine Absorber | 2-15% |
| Antioxidant | 0.25-2.0% |
| Flow Additive | 0.1-5.0% |

### Example 2—Preparation of UV Curable Blend Compositions

The components listed in Table 2 are combined using known techniques to form a UV curable resin blend composition including amounts of the first and second urethane acrylate resins as described hereinabove, along with an organic-inorganic hybrid acrylate, multifunctional acrylates, photoinitiators, light stabilizers, an antioxidant and a flow improver. One or more inert solvents as described above can be included in the composition to alter its flow properties.

TABLE 2

| | Weight Percent |
|---|---|
| | (exclusive of |
| Component: | solvent) |
| First Urethane | 10-40% |
| Acrylate Resin | |
| Second Urethane | 20-50% |
| Acrylate Resin | |
| Organic-Inorganic | 5-35% |
| Hybrid Acrylate | |
| Multifunctional | 5-55% |
| Acrylate #1 | |
| (functionality = 2) | |
| Multifunctional | 5-55% |
| Acrylate #2 | |
| (functionality = 3) | |
| Photoinitiator #1 | 0.25-2.5% |
| Photoinitiator #2 | 4-13% |
| Hindered Amine Light | 0.5-4.5% |
| Stabilizer | |
| Benzotriazine Absorber | 2-15% |
| Antioxidant | 0.25-2.0% |
| Flow Additive | 0.1-5.0% |

### Example 3—Preparation of a Preferred UV Curable Coating Composition

The following components are introduced into a stainless steel container and all components are mixed under agitation until a homogenous mixture is formed.

TABLE 3

| | Parts by |
|---|---|
| Formulation A: | Weight |
| Isopropanol | 42.5 |
| Secondary butyl alcohol | 12.0 |
| Desmolux VP LS2308 (Bayer) | 12.0 |
| functionality ca. 3.8 | |
| Ebecryl 8301 (Cytec), | 12.3 |
| functionality ca. 6. | |
| Trimethylolpropane | 9.0 |
| triacrylate | |
| SR833S (Sartomer) | 3.5 |
| Irgacure 819 (Ciba) | 0.55 |
| Irgacure 2959 (Ciba) | 2.7 |
| Irgacure 127 (Ciba) | 1.1 |
| Tinuvin 123 (Ciba) | 0.8 |
| CGL 0777 MPA (Ciba) | 4.0 |
| Irganox 1035 (Ciba) | 0.25 |
| Byk 301 (Byk-Chemie) | 0.30 |

### Example 4—Preparation of Coated Plastic Article by Flowcoat Method

Formulation A of Example 3 is further reduced with a non-aggressive inert solvent to achieve a specific gravity that will result in desirable film thickness range upon cure. The preferred specific gravity is in the range of less than about 0.975. Coating is applied to an injection molded polycarbonate lens mounted on a fixture by a flowcoat method in which coating is applied only to the top and side surfaces of the lens. The wet coated lens is subjected to a short ambient flash followed by a convection heated air flash to evaporate solvent. The wet coated lens is then exposed to irradiation with a 240 W/cm standard mercury lamp at intensity of about 450 mW/cm² in air resulting in a coated article with a coating dry film thickness of about 8-12 microns. The produced coated lens has properties of high optical clarity as well as superior performance properties as described below in PERFORMANCE TABLE:

PERFORMANCE TABLE I

| Evaluation Test | Performance Result |
|---|---|
| Initial Adhesion per ASTM | OK |
| D3359 | |
| Scratch and Abrasion | |
| Testing including: | |
| Steel Wool per FMVSS108 | Minor Scratching OK |
| Taber Abrasion per ASTM | |
| D1044 | |
| Moisture Resistance | |
| Testing including: | |
| 60° C. Water Immersion × | OK |
| 240 hrs | |
| 50° C. Humidity Cabinet × | OK |
| 240 hrs | |
| Hydrolysis Testing | OK |
| Cycle Testing including: | |
| Moisture-Cold Cycle | OK |
| Testing × 15 | |
| Thermal Cycle Testing × 15 | OK |
| Thermal Shock | OK |
| Chemical Testing including: | |
| Brake fluid | OK |
| Motor oil | OK |
| Unleaded gasoline | OK |
| Antifreeze | OK |
| Windshield washer fluid | OK |
| Car wash concentrate | OK |
| Accelerated Weathering | |
| Testing including: | |
| Xenon Arc with Daylight | OK-currently to 5000 hrs |
| Filtration | |
| Sunshine Carbon Arc | OK-currently to 3000 hrs |
| Natural Weathering Testing | |
| including: | |
| Florida 5° and 45° Exposure | OK-currently to 3 years |
| angles | |
| Arizona 5° and 45° Exposure | OK-currently to 3 years |
| angles | |

### Example 5—Alternative Preferred UV Curable Coating With Further Improved Surface Hardness

The following components are introduced into a stainless steel container and all components are mixed under agitation until a homogenous mixture is formed.

TABLE 4

| | Parts by |
|---|---|
| Formulation B: | Weight |
| Isopropanol | 40.8 |
| Secondary butyl alcohol | 10.6 |
| Desmolux VP LS2308 (Bayer) | 10.2 |
| functionality ca. 3.8 | |
| Ebecryl 8301 (Cytec), | 12.8 |
| functionality ca. 6. | |
| Etercure 601C-35 (Eternal) | 4.4 |
| Trimethylolpropane | 8.0 |
| triacrylate | |
| SR833S (Sartomer) | 3.5 |
| Irgacure 819 (Ciba) | 0.55 |
| Irgacure 127 (Ciba) | 3.8 |
| Tinuvin 123 (Ciba) | 0.8 |
| CGL 0777 MPA (Ciba) | 4.0 |
| Irganox 1035 (Ciba) | 0.25 |
| Byk 301 (Byk-Chemie) | 0.3 |

### Example 6—Preparation of Coated Plastic Article by Spray Method

Formulation B of Example 5 from Table 4 is applied to an injection molded polycarbonate lens by a spray method using a conventional spray gun mounted on a robot. A programmed spray pattern is used to achieve consistent coverage of the coating and cured dry film thickness in the range of 8 to 12 microns. The wet coated lens is subjected to heated convection air to evaporate solvent prior to an irradiation with a 240 W/cm standard mercury lamp at intensity of about 450 mW/cm² in air.

Evaluation of Formulation B is described below in TABLE 2:

PERFORMANCE TABLE II

| Evaluation Test | Performance Result |
|---|---|
| Initial Adhesion per ASTM | OK |
| D3359 | |
| Scratch and Abrasion | |
| Testing including: | |
| Steel Wool per FMVSS108 | Negligible Scratching |
| Taber Abrasion per ASTM | OK |
| D1044 | |
| Moisture Resistance | |
| Testing including: | |
| 60° C. Water Immersion × | OK |
| 240 hrs | |
| 50° C. Humidity Cabinet × | OK |
| 240 hrs | |
| Hydrolysis Testing | OK |
| Cycle Testing including: | |
| Moisture-Cold Cycle | OK |
| Testing × 15 | |
| Thermal Cycle Testing × 15 | OK |
| Thermal Shock | OK |
| Chemical Testing including: | |
| Brake fluid | OK |
| Motor oil | OK |
| Unleaded gasoline | OK |
| Antifreeze | OK |
| Windshield washer fluid | OK |
| Car wash concentrate | OK |
| Accelerated Weathering | |
| Testing including: | |
| Xenon Arc Daylight | OK-currently to 5000 hrs |
| Filtration | |
| Sunshine Carbon Arc | OK-currently to 3000 hrs |
| Natural Weathering Testing | |
| including: | |
| Florida 5° and 45° Exposure | OK-currently to 3 years |
| angles | |
| Arizona 5° and 45° Exposure | OK-currently to 3 years |
| angles | |

The above examples demonstrate that preferred UV curable compositions of the invention, when applied to a molded article and UV cured, will provide enhanced chemical and durability properties. It should be understood, however, that modifications can be made to adapt the invention to similar uses without changing the principle features.

Provided below are two alternative formulations in accordance with the present invention.

Alternative Formulation 1: Part A comprises a modified aliphatic urethane acrylate derived from H12MDI triisocyanurate (60-75% by weight) reacted with a proprietary blend of hydroxyethyl acrylate (40-55%) and a dendritic polyol based on polycaprolactone (MW 800-1,200) with hydroxyl value 300-350 mg KOH/g (25-35%). The resulting resin has functionality of 4.2-4.8, MW of 1,400-1,600 g/mol, and contains 15-25% by weight of phase-separated nanodomains (10-25 nm) created through controlled incompatibility between the dendritic segments and linear segments. Part B comprises a hyperbranched urethane acrylate synthesized by sequential addition of isophorone diisocyanate to a pentaerythritol core followed by capping with a mixture of hydroxyethyl acrylate (70-80%) and 2-hydroxy-3-phenoxypropyl acrylate (20-30%), resulting in a gradient functionality structure with higher crosslinking density at the core (functionality 6.5-7.5) and lower at the periphery (functionality 3.5-4.5), with overall MW of 900-1,100 g/mol.

Alternative Formulation 2: Part A comprises a dual-cure capable aliphatic urethane acrylate containing 15-25% by weight of silane-terminated branches grafted onto an HDI isocyanurate backbone (55-65%), with the acrylate functionality provided by reaction with 4-hydroxybutyl acrylate (30-40%) and the silane functionality provided by 3-isocyanatopropyltrimethoxysilane (8-12%). The resulting resin exhibits primary UV-cure through the acrylate groups and secondary moisture-cure through the silane groups, providing ongoing crosslinking in shadowed areas and self-healing properties during aging. Part B comprises a core-shell structured urethane acrylate with a rigid polyisocyanurate core derived from IPDI (25-35%) and a flexible shell derived from polytetramethylene glycol (MW 500-700, 20-30%) and terminated with a hydroxy-functional UV stabilizer covalently bound to the polymer chain through urethane linkages, wherein the UV stabilizer comprises a benzotriazole structure (5-10%) functionalized with hydroxyl groups that participate in the urethane-forming reaction.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure. Other embodiments are set forth in the following claims.

What is claimed and desired to be secured by Letters Patent of the United States is:

1. A UV curable coating composition, comprising: a first aliphatic urethane acrylate resin formed by the reaction of an aliphatic polyisocyanate component containing iminooxadiazine dione, isocyanurate, uretdione, urethane, allophanate, biuret and/or oxadiazine trione groups, with an alcohol component containing at least one monobasic, hydroxyl-functional linear or branched alkyl ester of meth(acrylic) acid; and a second aliphatic urethane acrylate resin formed by the reaction of a multifunctional acrylate with an aliphatic urethane based on a polymer of alkyl carbomoncycle diisocyanate.

2. The composition of claim 1, also comprising one or more inert solvents.

3. The composition of claim 2, wherein, exclusive of the inert solvent(s), the composition is comprised about 10% to about 40% by weight of a first aliphatic urethane acrylate resin.

4. The composition of claim 3, wherein, exclusive of the inert solvent(s), the composition is comprised about 20% to about 50% by weight of the second aliphatic urethane acrylate resin.

5. The composition of claim 4, wherein the first urethane acrylate resin has a molecular weight of about 800 to about 2,500 g/Mol and the second urethane acrylate has a molecular weight of about 500 to about 2,000 g/Mol.

6. The composition of claim 4, wherein the first urethane acrylate contains about 3 to about 5. polymerizable acrylate groups per molecule.

7. The composition of claim 6, wherein the second urethane acrylate contains about 4 to about 7 polymerizable acrylate groups per molecule.

8. The composition of claim 1, also comprising at least one engineered nanoparticle selected from the group consisting of nano-silica, nano-alumina, nano-zirconia, nano-ceria, nano-zinc oxide, and nano-titanium dioxide, wherein said nanoparticle has a particle size of 5-150 nm.

9. The composition of claim 8, wherein said nanoparticles comprise about 0.5% to about 20% by weight of the composition, exclusive of any inert solvent present.

10. The composition of claim 1, also comprising at least one carbon-based nanomaterial selected from the group consisting of graphene, graphene oxide, carbon nanotubes, and fullerenes.

11. The composition of claim 1, also comprising at least one multifunctional photoinitiator having both photoinitiating moieties and reactive acrylate or methacrylate groups that become chemically incorporated into the polymer network during curing.

12. The composition of claim 1, also comprising a dual-cure system comprising both photoinitiators for UV curing and at least one component selected from the group consisting of moisture-reactive components, thermal initiators, and oxidative curing components.

13. A UV curable coating composition, comprising: a first aliphatic urethane acrylate resin formed by the reaction of an aliphatic polyisocyanate component with an alcohol component; a second aliphatic urethane acrylate resin different from the first aliphatic urethane acrylate resin; at least one engineered nanoparticle with a particle size of 5-150 nm; and at least one photoinitiator system optimized for LED UV curing.

14. The composition of claim 13, wherein the LED UV curing optimized photoinitiator system comprises at least one photoinitiator with absorption maxima between 365 nm and 405 nm.

15. The composition of claim 13, wherein the engineered nanoparticle is surface-modified to improve dispersion and compatibility with the urethane acrylate resins.

16. The composition of claim 13, further comprising at least one self-healing component selected from the group consisting of microcapsules containing reactive healing agents, components forming reversible chemical bonds, phase-separated healing additives, and shape memory components.

17. A process for forming a coated article, comprising: coating an article with a coating composition according to claim 1; and curing the coating composition using LED UV radiation with peak emission between 365 nm and 405 nm.

18. The process of claim 17, wherein said curing is performed under an inert atmosphere to eliminate oxygen inhibition.

19. The process of claim 17, wherein said coating is applied using a method selected from the group consisting of electrostatic spray application, digital coating technologies, and in-mold coating.

20. A product, comprising: a molded plastic article selected from the group consisting of optical display components, architectural glazing, medical device housings, electronic device components, and 3D printed parts; and a cured coating formed with a composition according to claim 1.
